(19) United States
(12) Patent Application Publication
(10) Pub. No.: US 2023/0211334 A1
(43) Pub. Date: Jul. 6, 2023

(54) PIPETTING DEVICE WITH GAS-SOUND-TRIGGERED DISPENSING OF FLUID AMOUNTS PREFERABLY IN THE RANGE OF 10 TO 500 NL

(71) Applicant: Hamilton Bonaduz AG, Bonaduz (CH)

(72) Inventors: Fridolin Gysel, Adliswil (CH); Jonas Hilti, Balzers (LI)

(21) Appl. No.: 17/928,456

(22) PCT Filed: Jun. 7, 2021
(86) PCT No.: PCT/EP2021/065185

§ 371 Date: Nov. 29, 2022

(30) Foreign Application Priority Data
Jun. 10, 2020 (DE) 10 2020 115 515.8

(51) Int. Cl. B01L 3/02; G01N 35/10

(52) U.S. Cl. CPC B01L 3/0227; G01N 35/1009; B01L 2400/0436; B01L 2200/146; B01L 2400/0478

(57) ABSTRACT

A pipetting device for outputting amounts of a dosing fluid of less than 1 μl including a fluid volume; a pipetting plunger that can be moved along a plunger path, wherein a displacement of the pipetting plunger brings about a first pressure change in the fluid volume; a movement drive which is force-transmittingly connected to the pipetting plunger in order to drive the pipetting plunger such that it moves along the plunger path; a sound source which is designed to generate at least one sound impulse as a second pressure change in the fluid volume; and a control device which is designed to control the movement drive and the sound source, the pipetting device having a pipetting channel which extends along a channel axis and in which both the pipetting plunger is moveably accommodated along the channel axis as the plunger path and the fluid volume is accommodated, wherein the fluid volume includes a working gas which wets a plunger surface of the pipetting plunger, wherein, in addition, the sound source is designed and arranged to generate the at least one sound impulse in the working gas.

This application claims priority in PCT application PCT/EP2021/065185 filed on Jun. 7, 2021, which claims priority in German Patent Application DE 10 2020 115 515.8 filed on Jun. 10, 2020, which are incorporated by reference herein.

The present invention concerns a pipetting device for dispensing amounts of a dosing fluid of less than 1 μl, comprising:
A fluid volume,
A pipetting piston displaceable along a piston path, where a displacement of the pipetting piston effects a first pressure change in the fluid volume,
A movement drive which is connected with the pipetting piston in a force-transmitting manner in order to drive the pipetting piston to a movement along the piston path,
A acoustic source, which is designed to produce at least one acoustic pulse as a second pressure change in the fluid volume,
A control device designed to control the movement drive and the acoustic source.

The present invention concerns in particular a pipetting device which can dispense with repetition accuracy dosing fluid amounts in the two-digit nanoliter range. Preferably the pipetting device can dispense with repetition accuracy dosing fluid amounts of up to 50 nl, especially preferably up to 10 nl.

### BACKGROUND OF THE INVENTION

Pipetting devices for dispensing such small fluid amounts in the range of 999 to 10 nl, in particular in the two-digit nanoliter range, are needed for example for screening procedures in pharmaceutical and biopharmaceutical applications in which a very valuable test material in the smallest possible doses is brought into contact with as many reaction materials as possible in order to ascertain the reactivity and behavior of the test material as comprehensively as possible.

A dosing device with the features quoted at the beginning is known from US 2009/0060796 A1. The dispensing, i.e. releasing, of small dosing fluid amounts in the low three-digit or the two-digit nanoliter range takes place in the known dosing device by means of a conically focused acoustic pulse emitted by the acoustic source. A concavely shaped acoustic output surface of the known acoustic source emits the conically focused acoustic pulse, where the position of the focus, in the shape of the conical tip of the acoustic pulse, is determined by the curved shape of the acoustic output surface. The pressure in the dosing fluid can be changed by means of a movable piston in such a way that a meniscus, located at the pipetting aperture of the known dosing device, of the dosing fluid reservoir accommodated in the dosing device lies as accurately as possible at the location of the focus of the acoustic pulse.

By means of the piston there can besides dosing fluid be conveyed into the accommodating space for the accommodation of a dosing fluid reservoir, from which the small dosing fluid amounts are dispensed. Thus the dispensed dosing fluid amounts can be topped up again in the dosing fluid reservoir.

The dosing fluid reservoir of the known device is always located in an accommodating space provided specifically for same and fills up the latter completely. The accommodating space is therefore gas-free. A pressure change effected by the piston through its displacement is exerted directly on the dosing fluid reservoir. A pipetting surface facing towards the dosing fluid reservoir is wetted by dosing fluid.

The acoustic source is preferably likewise arranged in the dosing fluid reservoir, such that the acoustic output surface is likewise wetted by dosing fluid. That notwithstanding, the acoustic output surface can also be wetted by a working gas. Then the focused acoustic pulse emitted by the acoustic output surface propagates first in the working gas, crosses a first space wall which encloses a space in which the acoustic source is arranged and which is filled only with working gas, crosses a second space wall which encloses a space in which the pipetting aperture is configured and which is filled only with dosing fluid, and impinges in a focused manner on the meniscus, which is arranged in the pipetting aperture, of the dosing fluid reservoir as an interface of the dosing fluid reservoir to the atmosphere surrounding the pipetting aperture.

The construction and the operation of the dosing device known from US 2009/0060796 A1 are extraordinarily complicated.

A further dosing device, which is suitable for effecting the dispensing of very small dosing fluid amounts at a pipetting aperture with acoustic waves, is known from WO 00/45955 A1. In the dosing device of WO 00/45955 A1 too, as in US 2009/0060796 A1, acoustic waves are produced by means of piezo elements. The piezo elements surround a tube which defines the pipetting duct. The tube is locally contracted radially for a brief time through pulse-like activation of the piezo elements, whereby a pressure surge is initiated in the dosing fluid accommodated in the tube, which propagates in the incompressible dosing fluid and finally leads at a pipetting aperture to the dispensing of a droplet of the dosing fluid. The pipetting device known from WO 00/45955 A1 functions only with an adequately filled pipetting duct tube, since the contractions of the piezo elements have to be transmitted directly to the incompressible dosing fluid with the mediation of the pipetting duct tube in order to be able to effect at the pipetting aperture the detaching of a droplet of less than 1 μl.

As regards the further state of the art, reference is made additionally to U.S. Pat. No. 6,861,034 B1 which works with acoustic pulses focused by means of Fresnel lenses and likewise is constructed in a very complicated way.

### SUMMARY OF THE INVENTION

It is the task of the present invention to develop the pipetting device mentioned at the beginning in such a way that it allows, with the simplest construction and most robust operation possible, a dispensing with repetition accuracy of dosing fluid amounts of less than 1 μl down to 50 nl or even 10 nl.

This task is solved by the present invention with a pipetting device which exhibits the features mentioned at the beginning and which additionally comprises a pipetting duct extending along a duct axis, in which both the piston is accommodated movably along the duct axis as the piston path and the fluid volume is accommodated, where the fluid volume comprises a working gas which wets a pipetting surface of the pipetting piston, where furthermore the acoustic source is configured and arranged for producing at least one acoustic pulse in the working gas.

Other than in the aforementioned dosing device of US 2009/0060796 A1, the working gas is used as a force-transmitting medium both for the pipetting piston and for the acoustic source. In the dispensing-ready operational state, the fluid volume of the pipetting device according to the invention comprises a dosing fluid reservoir in the pipetting duct, out of which the dosing fluid amounts are to be dispensed in a gas-sound-induced manner, and comprises a working gas volume which is enclosed between the acoustic source and the pipetting piston on the one side and the dosing fluid reservoir on the other. The enclosed amount of working gas need not be the same for every pipetting process. If, however, a dosing fluid reservoir is accommodated in the pipetting duct, then the amount of working gas is essentially constant when neglecting evaporation processes in the dosing fluid reservoir and any possible leaks.

The pipetting piston can, using a conventional air displacement method, aspirate dosing fluid into the pipetting duct by means of the first pressure change and can, which will be discussed below in further detail, by effecting a first pressure change, influence the shape of a pipetting aperture-proximal meniscus of the aspirated dosing fluid reservoir.

The acoustic source can, by outputting the at least one acoustic pulse, produce the second pressure change and thereby effect the dispensing detachment of a droplet at the pipetting aperture-proximal meniscus as the desired small dosing fluid amount. In this process the acoustic source will normally output an acoustic pulse whose duration, amplitude, and frequency as variable parameters allow the changing of the dosing fluid amount dispensed by means of the acoustic pulse. The varying of the parameters takes place through the control device, for example in accordance with a specified calibration information, which for a given dosing fluid assigns different acoustic pulse forms to different dosing fluid amounts to be dispensed. The term ‘acoustic pulse form’ denotes in the present application the characterization of an acoustic pulse through quantitative choice of the aforementioned parameters. Acoustic pulse forms can therefore differ in terms of duration, amplitude, in particular amplitude as a function of time, frequency, etc.

As an acoustic pulse there is understood here at least one acoustic part-wave with a duration of one oscillation period or shorter, for instance a half-wave. Since preferably at the end of the output of the acoustic pulse, an acoustic output surface which outputs the acoustic pulse is back in the starting position in which it was immediately before the output of the acoustic pulse, preferably an acoustic pulse is either a half-wave or a complete acoustic wave. Of these alternatives, the complete acoustic wave is preferred, comprising a complete longitudinal oscillation with positive and negative amplitude, i.e. with the duration of an oscillation period. With a positive amplitude, i.e. in the positive coordinate direction going out from the starting position of the acoustic output surface, the acoustic output surface of the acoustic source moves from its starting position towards an observer situated in front of the acoustic output surface in the intended acoustic radiation direction, with a negative amplitude, i.e. in the negative coordinate direction going out from the starting position of the acoustic output surface, away from the observer. In this process, for the configuration of a for triggering a dispensing of a small dosing fluid amount mentioned in the present application it is preferred if the magnitude of the negative amplitude is smaller than that of the positive amplitude and/or if the deflection of the acoustic output surface for emitting an acoustic pulse lasts a shorter time in the negative coordinate range than in the positive coordinate range.

The output of a preferably sharp acoustic pulse therefore begins with a deflection of the acoustic output surface in the positive coordinate direction, reaches its maximum value at the positive amplitude, returns from there to the starting position, whereupon the acoustic output surface is deflected in the negative coordinate direction, reaches its negative amplitude and returns again to its starting position. An overshoot of the acoustic output surface, which is irrelevant for a propagation of a second pressure fluctuation, can occur due to inertia but is negligible.

In principle, the acoustic source can also be designed to emit continuous sound waves with a duration of several oscillation periods, although the emission of continuous sound waves with a duration of several oscillation periods for the acoustic pressure-induced dispensing of small dosing fluid amounts is less relevant than the emission of sharp pressure pulses in the form of acoustic pulses with a duration of not more than one oscillation period. A sound wave can be regarded as a sequence of a plurality of acoustic pulses following one another without interruption.

Indeed, given the compressible working gas arranged between the dosing fluid reservoir on the one hand and the pipetting piston as well as the acoustic source on the other, there is a gas spring situated between the pressure changing instruments and the dosing fluid reservoir which makes precise control of the pipetting device more difficult. However, on the other hand known and proven air displacement methods can be used in the pipetting device. Over and above that, the acoustic source can be actuated to emit so many different acoustic pulse forms that for nearly every dosing fluid and nearly every dosing fluid amount to be dispensed in the range below 1 μl, preferably below 500 μl, but above 50 nl, preferably above 10 nl, a suitable acoustic pulse form can be found and used.

The complexity of the control system is consequently readily manageable through one-time ascertaining of calibration information, where the calibration information links together the dosing fluid or dosing fluid class, the acoustic pulse form, and the dispensed dosing fluid amount as parameters. This calibration information, however, need only be prepared once and can then be used repeatedly in the pipetting devices according to the invention. In contrast, there is a considerable simplification of the structural layout of the pipetting device, which essentially corresponds to a conventional air displacement pipetting device which is designed for coupling gas sound into the working gas in the pipetting duct.

For the coupling of sound directly into the working gas, the acoustic source exhibits an acoustic output surface producing the at least one acoustic pulse, which preferably is wetted by the working gas. In the overwhelming majority of cases, the acoustic output surface will be a membrane which in a manner known per se can be excited to oscillate and thereby to output an acoustic pulse. The excitation can take place by means of a plunger coil, by means of a piezo element, magnetostatically, electrostatically, or electromagnetically. Appropriate loudspeakers as acoustic sources are well-known. Air-motion transformers or ribbon loudspeakers can also be acoustic sources of the pipetting device.

Beyond membrane loudspeakers, membrane-free loudspeakers should also not be excluded as acoustic sources, such as for instance plasma loudspeakers. In this case, the flame front of the plasma flame as an acoustic output surface is preferably wetted by the working gas.

Admittedly, it can never be ruled out that besides the gas sound, structure-borne sound is also produced by the acoustic source, for instance in a duct tube which defines the pipetting duct and thereby takes up at least part of the working gas. Nevertheless, in the present case the acoustic energy transferred per unit of time by the working gas to the dosing fluid reservoir is quantitatively larger than any acoustic energy transferred by structure-borne sound. Unavoidable structure-borne sound plays only a subordinate part.

Spatially, the acoustic source can additionally to the pipetting piston be provided in the pipetting duct by having an ancillary space with an ancillary space volume projecting from the pipetting duct. The ancillary space volume forms with the duct volume of the pipetting duct a contiguous, working gas-containing volume. The acoustic source produces the at least one acoustic pulse in the ancillary space volume. Since the ancillary space volume forms a contiguous volume with the duct volume, an acoustic pulse produced in the ancillary space volume can readily propagate towards the pipetting aperture in the working gas accommodated in the pipetting duct.

According to the present application, a duct axis is understood to be a virtual centerline which proceeds in the pipetting duct from the pipetting piston away in the direction towards a pipetting aperture. The pipetting duct preferably proceeds from a pipetting aperture up to an operating position of the pipetting piston which is furthest away from the pipetting aperture along a straight duct axis. This, however, need not be the case. The duct axis can also have a bent and/or angled course, respectively. Then the pipetting duct normally exhibits a pipetting aperture-distal branch which accommodates the pipetting piston and a pipetting aperture-proximal branch which is angled relative to the former.

In principle, the acoustic source can be accommodated in the ancillary space, which however can lead to undesirably high ancillary space volumes. An advantageously small ancillary space volume can be obtained by having the acoustic output surface form a boundary wall of the ancillary space. Then a major part of the acoustic source can be arranged outside the ancillary space and thereby outside the ancillary space volume. In the case of a bounding of the ancillary space by the acoustic output surface, let a deflection of the acoustic output surface from its starting position which decreases the ancillary space volume and therefore normally triggers an overpressure pulse, be the positive coordinate direction of the deflection of the acoustic output surface. Conversely, let a deflection of the acoustic output surface relative to its starting position which increases the ancillary space volume be the negative coordinate direction of the deflection of the acoustic output surface.

In principle, the pipetting device presented here functions regardless of the specific shape of the ancillary space. Preferably, however, the ancillary space is so shaped that it supports a propagation of an acoustic pulse produced by the acoustic source towards the dosing fluid reservoir. This can be achieved by the ancillary space exhibiting an ancillary duct extending along an ancillary duct axis which opens into the pipetting duct, where the ancillary duct axis encloses an angle with the duct axis. Preferably the ancillary duct is shorter than the pipetting duct. Likewise preferably the ancillary space volume enclosed by the ancillary duct is smaller than the duct volume of the pipetting duct. Preferably the ancillary duct axis is straight.

In the case of the angled pipetting duct described above, the ancillary duct can proceed in straight extension of the pipetting aperture-proximal branch of the pipetting duct. Then the ancillary duct axis and the section of the duct axis in the pipetting aperture-proximal branch of the pipetting duct are collinear. The acoustic source can then emit the acoustic pulse in a straight line towards the pipetting aperture.

The angle enclosed between the ancillary duct axis and the pipetting duct axis can be an acute angle, which the ancillary duct axis then preferably encloses with the pipetting piston-accommodating branch of the pipetting duct and of the associated duct axis section. The ancillary duct axis can enclose a right angle with the duct axis, which is preferable due to the improved installation space utilization possible through this arrangement.

For better monitoring of a dispensing process and of several consecutive dispensing processes it is advantageous to know the pressure of the working gas. Therefore according to a preferred development of the present invention, the pipetting device exhibits a pressure sensor which detects a working gas pressure of the working gas in the fluid volume and outputs a pressure signal which represents the detected working gas pressure. The pressure signal is preferably output to the control device, which is designed to process the pressure signal in a data-relevant manner.

The ancillary duct opens into an outlet region in the pipetting duct. In order to be able to ascertain as quickly as possible both a first and a second pressure change, the pressure sensor is preferably arranged in such a way that it detects the working gas pressure in the outlet region. According to a preferred structural configuration, in the outlet region a detection duct in which the pressure sensor is arranged can go off from the wall of the outlet region. Through the design of such a detection duct, neither the pipetting duct nor the ancillary duct is disturbed by the pressure sensor. Arranging the pressure sensor in the pipetting duct volume itself is not necessary.

As already indicated above, the pipetting piston can also serve, through a second pressure change, to prepare a dosing fluid reservoir accommodated in the pipetting duct for subsequent dispensing.

Experiments thus far have shown that for the most accurate possible dispensing of a very small dosing fluid amount by a gas-sound-induced second pressure change it is of great advantage if the pipetting aperture-proximal meniscus wets the edge of the pipetting aperture and exhibits a planar shape. Such a state is readily producible immediately after an aspiration for which the pipetting aperture was slightly, i.e. in the submillimeter range, was immersed in an aspiration reservoir. Due to the immersion of the pipetting aperture during the aspiration, the edge of the pipetting aperture is wetted by dosing fluid and therefore by the pipetting aperture-proximal meniscus even after the end of the aspiration and after the extraction of the pipetting aperture from the aspiration reservoir. Due to the small immersion depth of the pipetting aperture in the aspiration reservoir during the aspiration, the pressure conditions at the pipetting aperture after the withdrawal of same from the aspiration reservoir do not change or change only to a negligible extent, such that the meniscus wetting the edge of the pipetting aperture exhibits an essentially planar shape.

After a first dispensing process, effected through a second pressure change, this state of an essentially planar meniscus wetting the edge of the pipetting aperture can be restored. Through the dispensing of a dosing fluid amount, the total quantity of dosing fluid accommodated in the pipetting duct decreases. Consequently, the mass of dosing fluid to be held in an equilibrium by the working gas also drops. After a dispensing process, the underpressure initially prevailing in the working gas no longer matches the amount of dosing fluid remaining in the pipetting duct. On the other hand, the dispensed dosing fluid amount is too small for the position of the pipetting aperture-proximal meniscus to have changed due to the dispensing. Instead, only its shape changes. The latter deforms increasingly concavely with an increasing dispensed amount of dosing fluid, i.e. bulges into the pipetting duct. By changing the working gas pressure, this bulging which is undesirable per se can be reversed or at least decreased quantitatively.

Thus preferably the control device is designed, on the basis of at least one pressure signal of the pressure sensor and on the basis of data stored in a data memory which can be interrogated by the control device, between a first, earlier dispensing of a dosing fluid amount of less than 1 μl and a second, later dispensing of a dosing fluid amount of less than 1 μl following the former immediately, each effected by a second pressure change, to condition a dosing fluid reservoir accommodated in the pipetting duct, where for this purpose the control device is designed,
To ascertain an initial quantity value which represents an initial quantity of dosing fluid which is accommodated in the pipetting duct after the dispensing of the first and before the dispensing of the second dosing fluid amount,
Depending on the ascertained initial quantity value and depending on initial quantity value-working gas pressure assigning information stored in the data memory, which to each of different initial quantity values assigns a target working gas pressure, to ascertain a target working gas pressure for the working gas present in the pipetting duct, and
To actuate the movement drive to move the pipetting piston in the pipetting duct in such a way that the actual working gas pressure detected by the pressure sensor corresponds to the ascertained target working gas pressure.

The initial quantity value-working gas pressure assigning information can be determined in the laboratory in advance for a plurality of dosing fluids, if desired as a function of the temperature and further parameters. It assigned to a dosing fluid amount accommodated in the pipetting duct the working gas pressure at which the pipetting aperture-proximal meniscus is likely to have a planar shape. The control device provides this working gas pressure through movement of the pipetting piston in the working gas accommodated in the pipetting duct.

Through the aforementioned conditioning procedure, a curvature of the pipetting aperture-proximal meniscus is at least quantitatively reduced, preferably eliminated.

The pipetting piston can be a conventional pipetting piston, which through a mechanical movement drive, for instance a spindle drive, is driven to move. The pipetting piston can, however, in a manner which is known per se, also exhibit one or several permanent magnets and serve as a rotor of a linear motor movement drive. In the latter case, the movement drive comprises magnetic coils energizable by the control device which surround the pipetting duct consecutively along the duct axis. The advantage of a pipetting piston movable by means of a linear motor lies in its high movement dynamics and in the possibility of backlash-free reversing of the direction of movement.

In principle, the initial quantity value of the dosing fluid amount accommodated in the pipetting duct before a dispensing process can be ascertained by the control device in an arbitrary manner, including gravimetrically. For the quickest possible ascertaining of the initial quantity value and thereby for achieving the fastest possible sequence of accurate dispensing processes, preferably the control device is designed to ascertain the initial quantity value on the basis of a preceding known initial quantity value and of a dosing fluid amount dispensed since the applicability of this preceding known initial quantity value. Consequently, the initial quantity value can be ascertained iteratively or incrementally, as the case may be. This is because the accommodated initial quantity and thereby the initial quantity value is known immediately after the aspiration of a dosing fluid reservoir. After each dispensing process, the preceding initial quantity value can be updated by the dispensed dosing fluid amount to a new initial quantity value.

In order to ascertain the dosing fluid amount dispensed in a dispensing process, the control device can be designed to ascertain a dosing fluid amount dispensed in a time interval on the basis of a number of acoustic pulses produced in this time interval by the acoustic source for the dispensing of dosing fluid amounts, on the basis of their respective acoustic pulse form, and on the basis of acoustic pulse-dispensing amount assigning information stored in the data memory, which for at least one dosing fluid assigns to different acoustic pulse forms a dosing fluid amount dispensed by the respective acoustic pulse form.

The acoustic pulse-dispensing amount assigning information can in turn be ascertained in advance in the laboratory for a plurality of dosing fluids, if desired taking into account further parameters, such as for instance the temperature. Then the control device can, on the basis of the emitted acoustic pulse forms, assess the dosing fluid amounts dispensed thereby. Alternatively, the control device can simply use the target dispensing amount of a preceding dispensing process.

A further option for quality assurance is introduced through knowledge of the position of the pipetting piston along the duct axis. Therefore the pipetting device preferably exhibits a piston position sensor for detecting the position of the pipetting piston along the duct axis, which outputs a piston position signal which represents the detected position of the pipetting piston. In the case of a linear motor-driven pipetting piston, this position sensor can comprise at least one Hall sensor.

Alternatively or preferably additionally, the pipetting device can exhibit an acoustic position sensor for detecting the position of an acoustic output surface of the acoustic source, which outputs an acoustic position signal representing the detected position of the acoustic output surface. The acoustic output surface here is preferably the acoustic output surface wetted by the working gas already mentioned above. Through a pressure prevailing in the working gas of the pipetting duct—this can be an overpressure or an underpressure relative to the ambient atmosphere of the pipetting device—the acoustic output surface can be deflected from its neutral position which is expected or required at the beginning of the emission of an acoustic pulse. As a consequence, the actuation of the acoustic source can, for emitting an acoustic pulse due to the disturbance by the pressure-induced deflection, effect the emission of a changed acoustic pulse differing from the intended target acoustic pulse. This can subsequently in turn effect the undesired dispensing of a changed dosing fluid amount differing from the intended target dosing fluid amount.

In order to ensure the highest possible dosing accuracy, the control device can be designed to displace the acoustic output surface before the beginning of the emission of an acoustic pulse, depending on the acoustic position signal, by actuating the acoustic source into a predetermined starting position. Thereby it can be ensured that the acoustic output surface, actuated from the predetermined starting position for emitting an acoustic pulse, emits as accurately as possible the acoustic pulse which the control device assigns in accordance with stored data to a dosing fluid amount which is to be dispensed.

For quality monitoring and/or assurance respectively, according to a preferred development of the present invention the control device can be designed to ascertain a target piston position of the pipetting piston from either
Initial quantity value-piston position assigning information stored in the data memory, which for at least one dosing fluid assigns different initial quantity values to each target piston position, or
Working gas pressure-piston position assigning information stored in the data memory, which for at least one dosing fluid assigns different target working gas pressures to each target piston position,

Where the control device is further designed, after actuation of the movement drive for changing the actual working gas pressure to the target working gas pressure, on the basis of the piston position signal to ascertain an actual piston position of the pipetting piston and to compare it with the target piston position and depending on the result of the comparison to output to an output device quality information about an accuracy of a previous dispensing process.

The use of initial quantity values and working gas pressures is functionally equivalent, since as described above, the target working gas pressure adjusted in the pipetting duct is based on an ascertained initial quantity value and thereby there exists an unambiguous and sufficient functional relationship between these values.

Once again the piston position assigning information, whether based on initial quantity values or on working gas pressures, can be ascertained in advance in the laboratory for a plurality of dosing fluids, if desired then while taking into account further parameters, such as the temperature.

The idea of quality monitoring is as simple as it is persuasive: When the actually dispensed dosing fluid amounts agree with the target dosing fluid amounts intended for a dispensing, the actual piston position will agree with the target piston position. If the actually dispensed dosing fluid amounts differ from the target dosing fluid amounts, for whatever reason, the initial quantity value assessed on the basis of the dispensed dosing fluid amounts does not accurately reflect the amount of dosing fluid reservoir actually accommodated in the pipetting duct, such that the pipetting piston during the adjustment of the target working gas pressure ascertained above does not come to lie at the target piston position, but at a piston position differing from it.

Since the dispensed dosing fluid amounts are very small and since furthermore at least a part of the value ascertainments described above are based on estimation procedures, then in order to avoid the output of too many warning messages in the case of supposedly faulty dispensing it is helpful if the control device is designed to output a quality information, in particular a warning message because of inaccurate dispensing, at least or preferably only when the difference between the actual piston position and the target piston position quantitatively exceeds a predetermined tolerance difference value. The tolerance difference value can be determined on the basis of the unavoidable dosing errors due to inaccuracies in the fabrication and operation of the pipetting device and on the basis of inaccuracies in the utilized estimation procedures of the value ascertainments.

In principle it is possible that the pipetting duct as a single-piece duct tube exhibits a pipetting aperture. On hygienic grounds, however, this is not preferred. Preferably the pipetting duct exhibits a pipetting aperture at which or through which a dosing fluid amount of less than 1 μl is dispensed, where the pipetting aperture is configured in a pipetting tip which is connected detachably with a pipetting duct section which accommodates the pipetting piston. The pipetting tip is regarded, in its state of being coupled to the rest of the pipetting duct section, as part of the pipetting duct. The pipetting tip can be a conventional pipetting tip with a nominal pipetting volume of e.g. 100 μl to 10 ml.

In a dispensing-ready operational state, the fluid volume comprises in addition to the working gas a dosing fluid reservoir, where the working gas wets an interface of the dosing fluid facing towards the pipetting piston. The pipetting device therefore works both with regard to the first pressure change and also the second pressure change according to the air displacement method, where the air displacement of the second pressure change is based on at least one acoustic pulse, that is, on a pressure fluctuation propagating in the working gas as a medium in the form of a longitudinal oscillation or a part thereof.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A pipetting device according to the invention against the end of an aspiration of a predetermined amount of dosing fluid,

FIG. 2 The pipetting device of FIG. 1 after the end of the aspiration procedure but still before the dispensing of a first dosing fluid amount through a gas-sound-induced second pressure change,

FIG. 3 The pipetting device of FIG. 2 after triggering by an acoustic pulse of a second pressure change in the working gas accommodated in the pipetting duct, but still before detaching of a dosing fluid amount,

FIG. 4 The pipetting device of FIG. 3 directly after detaching of a dosing fluid amount in droplet form,

FIG. 5 The pipetting device of FIG. 4, after dispensing of the dosing fluid amount with essentially constant working gas pressure without acoustic waves, and

FIG. 6 The pipetting device of FIG. 5 after a conditioning of the dosing fluid reservoir remaining in the pipetting duct for a subsequent further gas-sound-induced dispensing of a dosing fluid amount in the range from 500 nl to 10 nl, in particular two-digit nanoliter range.

### DESCRIPTION OF PREFERRED EMBODIMENTS

Referring now to the drawings wherein the showings are for the purpose of illustrating preferred and alternative embodiments of the invention only and not for the purpose of limiting the same, in FIGS. 1 to 6, a pipetting device according to the invention is labelled generally by 10. This exhibits a pipetting duct 11, comprising a pipetting duct tube or more specifically a cylinder 12, which extends along a duct path K configured as a straight duct axis. In this pipetting duct 11 there is accommodated movably along the duct path K a pipetting piston, or ‘piston’ for short, 14.

The piston 14 comprises two end caps 16 (for the sake of clarity, only the lower one is labelled in FIGS. 1 to 6 with a reference sign), between which a plurality of permanent magnets 18 (in the present example, three permanent magnets 18) are accommodated. In order to achieve a magnetic field with sharp separation along the duct path K, the permanent magnets 18 are polarized along the duct axis K and arranged pairwise with similar poles immediately adjacent to one another. From this arrangement there results a magnetic field originating from the piston 14, which to the greatest possible extent is uniform about the duct axis K, i.e. essentially rotation-symmetrical with respect to the duct axis K and which exhibits along the duct axis K a high gradient of the magnetic field strength, such that opposite polarization zones alternate with sharp separation along the duct path K. Thereby, for example through a piston position sensor arrangement 17 with a plurality of Hall sensors, high positional resolution in the position detection of the piston 14 along the duct axis K can be achieved and very efficient coupling of an external magnetic field to the piston 14 can be achieved.

The end caps 16 are preferably made from low-friction, graphite-comprising material, as is known for example from commercially available caps of Airpot Corporation in Norwalk, Conn. (USA). In order to be able to utilize as completely as possible the low friction provided by this material, the pipetting duct 11 preferably comprises a cylinder 12 made from glass, such that during a movement of the piston 14 along the duct axis K the graphite-comprising material slides with extremely low friction against a glass surface. The cylinder 12 and/or the end caps 16, however, can alternatively each also be made from an arbitrary other material.

The piston 14 consequently forms a rotor of a linear motor 20, whose stator is formed by the coils 22 surrounding the pipetting duct 11 (here by way of example there are depicted only four coils). The coils 22 consequently form a movement drive of the piston 14.

Let it be pointed out expressly that FIGS. 1 to 6 show merely a rough schematic longitudinal section depiction of a pipetting device 10 according to the invention, which in no way should be understood as being to scale. This also applies to movement and displacement paths, which are neither to scale nor are depicted in a correct ratio to one another. Moreover, pluralities of components are depicted by an arbitrary component number, such as for instance three permanent magnets 18 and four coils 22. In actual fact, both the number of the permanent magnets 18 and also the number of the coils 22 can be larger or indeed smaller than the depicted number.

The linear motor 20, more precisely its coils 22, are actuated via a control device 24 which is connected with the coils 22 for signal transmission. As a signal there is deemed also the transmission of electric current for energizing the coils and thereby for producing a magnetic field through these.

The control device 24 is connected for signal transmission with a data memory 25 in which data are provided retrievably for the control device 24. The data memory 25 can be written to at least section-wise by the control device 24, such that the control device 24 can store data in the data memory 25.

At the dosing-side end 12a of the cylinder 12 there is attached detachably a pipetting tip 26 in a manner known per se. The connection of the pipetting tip 26 with the dosing-side longitudinal end 12a of the cylinder 12 is likewise depicted merely in rough schematic form.

The pipetting tip 26 defines a pipetting space 28 in its interior, which in the coupled state to the cylinder 12 is accessible from outside solely at the coupling-distal longitudinal end 26a through a single pipetting aperture 30. The pipetting tip 26 extends the pipetting duct 11 during its coupling to the cylinder 12 up to the pipetting aperture 30. Through the pipetting aperture 30, a dosing fluid 32 can be admitted into the pipetting space 28 through aspiration by means of movement of the piston 14 away from the pipetting aperture in a manner known per se.

A pipetting surface 14a of the piston 14 faces towards the pipetting aperture 30 of the pipetting tip 26 in like manner to a coupling-side longitudinal end 11a of the pipetting duct section 11b arranged permanently at the pipetting device 10, which coincides with the dosing-side end 12a of the cylinder 12. In the present example, the pipetting surface 14a is formed by an end surface of the end cap 16 facing towards the dosing aperture 30 in the axial direction with respect to the duct path K.

In the pipetting duct 11 there is situated at least in one section lying nearer to the piston 14 a working gas 34 as a force-transmitting medium, namely such that it permanently wets the pipetting surface 14a. A movement of the piston 14 along the duct axis K effects a pressure change in the working gas 34, preferably air, which in turn leads to a force action on any initial quantity 31 of dosing fluid 32 which is possibly accommodated in the pipetting space 28.

From the pipetting duct 11 there branches off along an ancillary axis N an ancillary space 36, which exhibits an ancillary duct 38 directly joined to the pipetting duct 11 and an ancillary chamber 40 joined to the longitudinal end of the ancillary duct 38 remote from the pipetting duct 11.

The pipetting device 10 further comprises an acoustic source 42, whose acoustic output surface 42a forms a wall of the ancillary chamber 40 and bounds it. The acoustic output surface 42a emits sound along the ancillary axis N into the working gas 34. The acoustic output surface 42a can be displaced by means of an actuator 42b, such as for example a plunger coil or another known actuator type, in order to emit an acoustic pulse.

An acoustic position sensor 43 detects the position of the acoustic output surface 42a and outputs to the control device 24 an acoustic position signal representing the position of the acoustic output surface 42a. The control device is preferably designed to actuate the actuator 42b before the emitting of an acoustic pulse in accordance with the acoustic position signal in such a way that before the emitting of an acoustic pulse the acoustic output surface 42a is situated in a predetermined position, such that the output of the acoustic pulse can begin in the predetermined position.

The ancillary duct 38 opens into an outlet region 44 in the pipetting duct 11, where in the depicted example the ancillary axis N and the duct axis K enclose a right angle, which makes possible an axially advantageously long drive distance fitted with coils 22 along the duct axis K. In the outlet region 44 there branches off a detection duct 46, through which a pressure sensor 48 is coupled with the working gas space of the pipetting duct 11 and of the ancillary space 36 for detecting the working gas pressure. In addition to the pressure sensor 48, a temperature sensor 50 can be provided for detecting the working gas temperature.

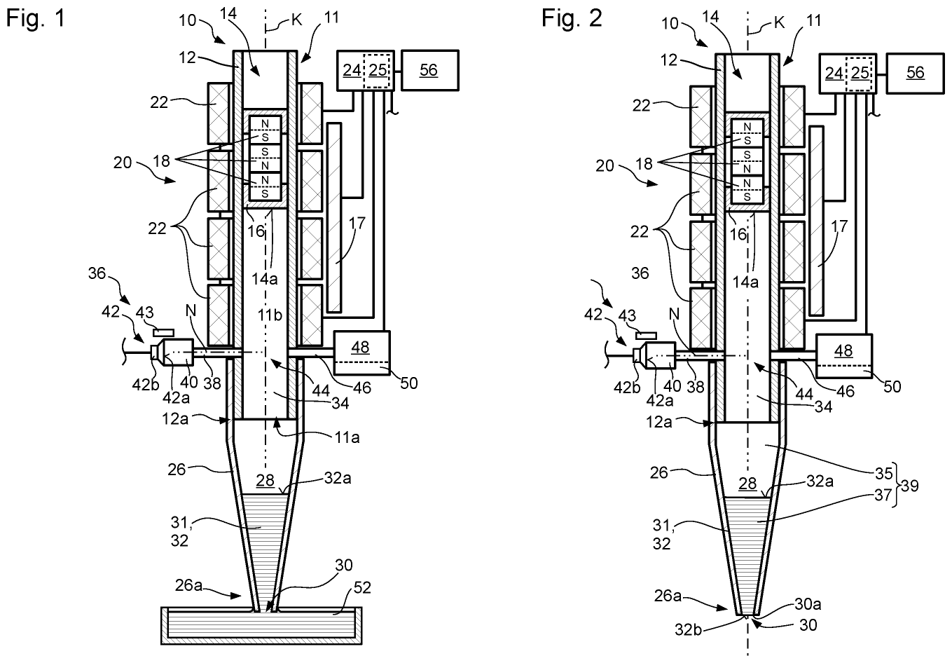

The volume of the ancillary space 36, the volume of the detection duct 46, and the volume of the pipetting duct form a common contiguous volume. The working gas volume 35 accommodated in the pipetting duct 11, in the ancillary space 36, and in the detection duct 46 and the volume 37 of the dosing fluid 32 accommodated in the pipetting space 28 form together a fluid volume 39 (see FIG. 2).

The acoustic source 42 which is controllable by the control device 24 emits sound, in particular an acoustic pulse, directly to the working gas 34, where the acoustic pulse propagates in the working gas 34, including in the direction towards the pipetting aperture 30 and an initial quantity 31 of dosing fluid 32 arranged above it. In particular, the actuator 42b of the acoustic source 42 is controllable by the control device 24.

For the purpose of differentiating, a pressure change effected by a movement of the piston 14 in the working gas 34 is designated a first pressure change and a pressure change effected by an output of an acoustic pulse into the working gas 34 is designated a second pressure change.

In FIG. 1, the pipetting device 10 is depicted with the coupling-distal longitudinal end 26a of the pipetting tip 26 immersed in an aspiration reservoir 52. The immersion depth is less than half a millimeter, preferably less than 0.2 mm. Through movement of the pipetting piston 14 away from the pipetting aperture 30, an initial quantity 31 of dosing fluid 32 is aspirated into the pipetting space 28. In FIG. 1, the aspiration process for taking in the initial quantity 31 is immediately before its conclusion.

In the example depicted in FIG. 2 of the pipetting device 10 immediately after conclusion of a conventional aspiration process by the pipetting device 10, there is accommodated in the pipetting space 28—and thereby in the pipetting device 10—a reservoir or more precisely an initial quantity 31 of dosing fluid 32.

Between the piston 14 and the dosing fluid 32 there is permanently present working gas 34, which serves as a force-transmitting medium not only between the piston 14 and the dosing fluid 32, but also between the acoustic source 42 and the dosing fluid 32. The acoustic output surface 42a too, is permanently wetted by working gas 34, in particular only by working gas 34. Preferably there is present between the pipetting surface 14a and the acoustic output surface 42a on the one hand and the dosing fluid 32 on the other only the working gas 34, possibly modified in its chemical composition in a negligible way by the intake of volatile constituents from the dosing fluid 32. The working gas 34 therefore also wets a pipetting aperture-distal meniscus 32a of the dosing fluid 32 accommodated in the pipetting space 28.

Due to the very small immersion depth during the aspiration, the pressure conditions at the pipetting aperture 30 after the lifting of the pipetting tip 26 from the aspiration reservoir 52 do not change or only in a negligible way. A pipetting aperture-proximal meniscus 32b is therefore, directly after the aspiration and after lifting the pipetting aperture 30 from the aspiration reservoir 52, essentially planar and wets an edge 30a of the pipetting aperture 30. These two conditions: Wetting of the edge 30a of the pipetting aperture 30 by the pipetting aperture-proximal meniscus 32b and a planar shape of the pipetting aperture-proximal meniscus 32b are optimal prerequisites for the most accurate dispensing possible of a very small dosing fluid amount by means of a second pressure change in the working gas 34 effected by the acoustic source 42.

Even with a completely emptied pipetting tip 26, the working gas 34 is arranged between the piston 14 and a dosing fluid 32, since the pipetting tip 26 is immersed in an appropriate dosing fluid reservoir for the aspiration of dosing fluid 32, such that in this state a meniscus of the dosing fluid 32 is present at least at the pipetting aperture 30. Consequently in every operational state of the pipetting device 10 which is relevant for a pipetting process, working gas 34 is present permanently and completely between the piston 14 and a dosing fluid 32 and separates them from one another.

The shape of the pipetting aperture-proximal meniscus 32b depends for example on the surface tension of the dosing fluid 32, on its density, on its viscosity, and on the wettability of the wall of the pipetting tip 26.

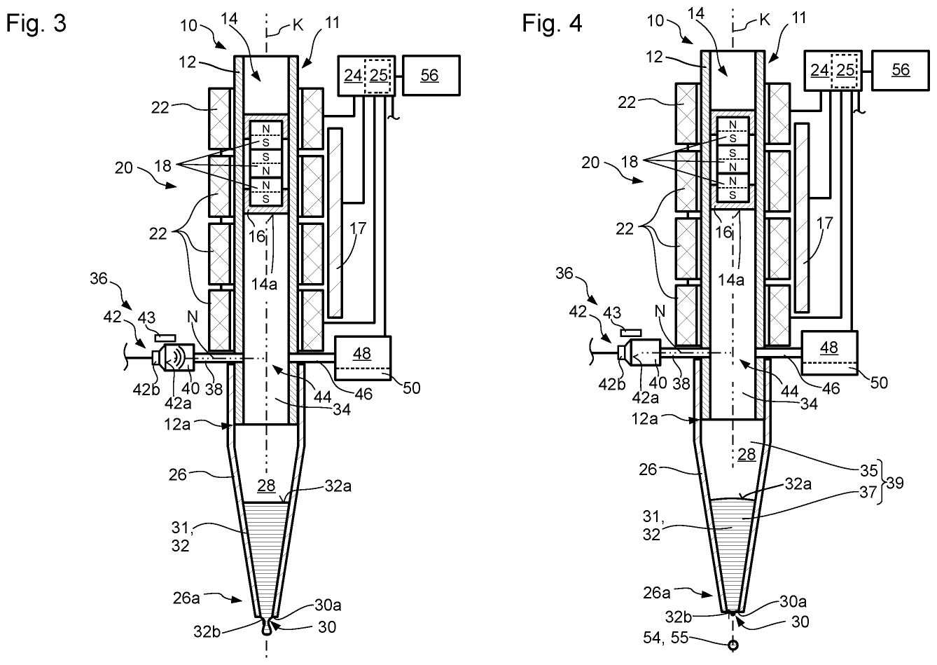

Starting from the state shown in FIG. 2, the acoustic source 42 emits in accordance with FIG. 3 over its acoustic output surface 42a an acoustic pulse into the working gas 34. Since sound is a pressure fluctuation propagating in the working gas 34, the acoustic pulse impinges as a pressure pulse on the pipetting aperture-distal meniscus 32a. In the essentially incompressible dosing fluid 32, the pressure pulse transmitted to the pipetting aperture-distal meniscus 32a propagates over the relatively short distance up to the pipetting aperture-proximal meniscus 32b largely unattenuated and reaches the pipetting aperture-distal meniscus 32b, where the pressure pulse, as depicted in FIG. 4, leads to the detaching of a small dosing fluid amount 54 which is flung along the duct axis away from the pipetting aperture 30.

Through a suitable choice of frequency, amplitude, and duration of the acoustic pulse, the control device 24 can trigger an acoustic pulse at the acoustic source 42 which for the given dosing fluid 32 at the given temperature leads to the detaching of a desired single dosing volume 54. The pipetting aperture-proximal meniscus 32b can, after the flinging way of the dosing fluid droplet 55, continue to reverberate briefly (see FIG. 4).

In the data memory 25 there is stored calibration information previously determined and verified in the laboratory, which for a given dosing fluid 32 assigns to a single dosing volume 54 which it is desired to dispense the acoustic pulse form appropriate to the dispensing in terms of duration, frequency, and amplitude. If desired, the calibration information can also take into account the temperature of the dosing fluid 32 to be dispensed and/or of the working gas 34 when assigning the appropriate acoustic pulse-form.

The calibration information can be stored in the data memory 25 as a characteristic diagram, normally a multidimensional characteristic diagram, or as an analytical parametric function with the input variables ‘dosing fluid’ or ‘dosing fluid class’ and single dosing volume, and where applicable fluid and/or working gas temperature. The dosing fluid or dosing fluid class can be determined either through an appropriate reference code or through substance parameters which characterize the dosing fluid and/or the dosing fluid class respectively, such as viscosity, density, etc. In this way, starting from the desired single dosing volume 54 of the known dosing fluid 32, the control device 24 can with the help of the calibration information ascertain the operational parameters for actuating the acoustic source 42 for emitting an appropriate acoustic pulse.

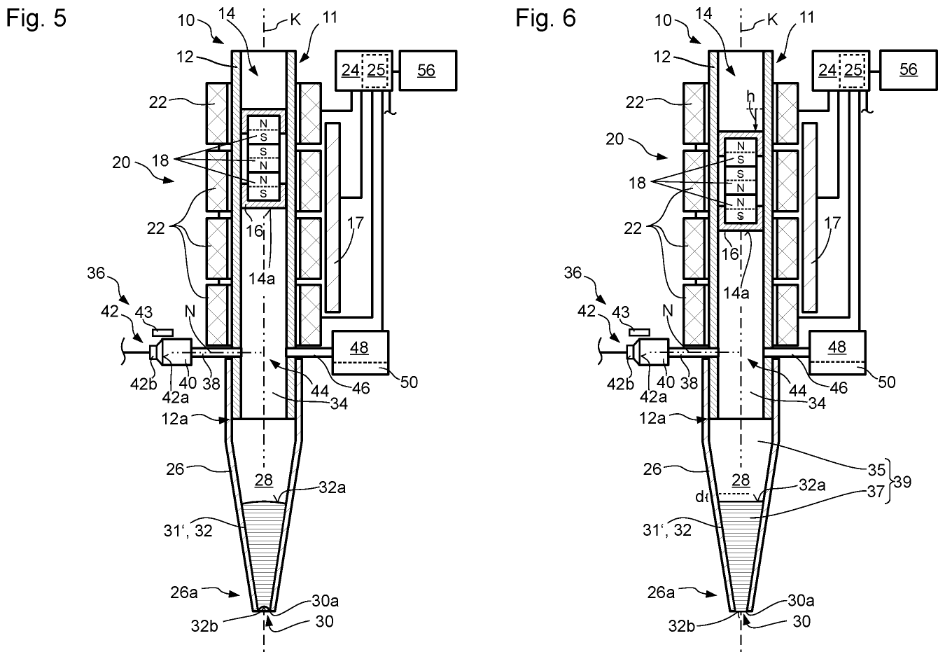

In the state shown in FIG. 5 of the pipetting device 10 after the end of the gas-sound-induced pulse-like dispensing process, the amount of dosing fluid 32 present in the pipetting space 28 is smaller by the single dosing volume 54 than before the dispensing. As before, the pipetting aperture-proximal meniscus 32b still wets the edge 30a of the pipetting aperture 30. Since the piston 14 is still in the same position as before the dispensing, the underpressure in the working gas 34 is no longer optimally appropriate to the amount of dosing fluid 32 remaining in the pipetting space 28, which forms an initial quantity 31′ for a subsequent further gas-sound-induced pulse-like dispensing.

Due to the static friction in place between the dosing fluid 32 and the pipetting tip 26, the mismatch between the working gas pressure and the remaining amount of dosing fluid 32 cannot be compensated for through a displacement of the dosing fluid 32 in the pipetting tip 26. A state of equilibrium is reached, therefore, through deformation of the meniscuses 32a and 32b. The meniscuses 32a and 32b consequently bulge inwards into the pipetting space 28. The pipetting aperture-distal meniscus 32a bulges convexly after the dispensing of the single dosing volume 54, the pipetting aperture-proximal meniscus 32b concavely. The depiction of the shapes of the meniscuses 32a and 32b in FIG. 5 is exaggerated for elucidation purposes.

For preparatory conditioning of subsequent further sound-induced dispensing, the control device 24 restores a planar pipetting aperture-proximal meniscus 32a.

Starting from the dispensed single dosing volume 54 and from the known previous initial quantity 31, the control device 24 assesses the amount of dosing fluid 32 remaining in the pipetting space 28 which forms an initial quantity 31′ for the subsequent further dispensing process. The initial quantity 31′ is the difference between the previous initial quantity 31 and the single dosing volume 54 dispensed therefrom.

On the basis of the so ascertained initial quantity 31′ or an initial quantity value representing the ascertained initial quantity 31′, the control device 24 retrieves from an initial quantity value-working gas pressure assigning information stored in the data memory 25 a target working gas pressure assigned to the ascertained initial quantity 31′. The initial quantity value-working gas pressure assigning information can in turn be stored in the data memory 25 as a characteristic diagram or as an analytical function, in particular as a numerical value function. The initial quantity value-working gas pressure assigning information was previously ascertained at least for the dosing fluid 32, preferably for a plurality of dosing fluids, in the laboratory.

Following this, the control device 24 moves the piston 14 along the piston axis K by energizing the coils 22, in order to adjust in the working gas 34 the retrieved target working gas pressure. With the help of the pressure sensor 38, the control device 24 can regulate the movement of the piston 14 in a control loop in accordance with the working gas pressure detected by the pressure sensor 38.

Once the target working gas pressure previously retrieved as being assigned to the ascertained initial quantity 31 has been adjusted in the working gas 34, the pipetting aperture-proximal meniscus 32b is likely to have again a planar shape, highly likely to have a less bulging shape than before the adjusting of the target working gas pressure.

At the end of the piston movement for producing the target working gas pressure, the piston 14 has been moved by a distance h towards the pipetting aperture 30 and the pipetting aperture-distal meniscus 32a has been lowered by the distance d.

The pipetting aperture-proximal meniscus 32b is only ‘likely’ to have a planar shape after the adjusting of the target working gas pressure, since the planar shape is reached once the previous dispensing process has been carried out correctly, i.e. if the emitting of the acoustic pulse has indeed led to the dispensing of the single dosing volume 54 linked with the emitted acoustic pulse form. Due to unexpected interference, such as for example drafts or mechanical knocks during the dispensing, the actually dispensed single dosing volume 54 can differ from the expected dispensed single dosing volume 54.

The control device 54 can therefore, according to a preferred development of the present invention, assess the quality of the preceding dispensing process or of the preceding dispensing processes simply but effectively.

In the data memory 25 there is stored for this purpose an initial quantity value-piston position assigning information likewise compiled in the laboratory in advance at least for the dosing fluid 32, preferably for a plurality of dosing fluids, which assigns to an ascertained initial quantity value after the above conditioning procedure and after the adjusting of a target working gas pressure which takes place through the conditioning procedure, to the piston 14 a target piston position. A working gas pressure-piston position assigning information is functionally equivalent to the initial quantity value-piston position assigning information, since through the aforementioned initial quantity value-working gas pressure assigning information, the initial quantity value and the associated target working gas pressure are unambiguously and sufficiently linked with one another.

By retrieving the initial quantity value-piston position assigning information, the control device 14 ascertains a target piston position assigned to the ascertained initial quantity 31′, and checks on the basis of the actual piston position ascertained by the position sensor arrangement 17 whether after the conditioning procedure for adjusting the target working gas pressure the piston 14 is situated at the correct position defined by the target piston position or at a position deviating from it.

If the actual piston position ascertained with the help of the position sensor arrangement 17 deviates by more than a predetermined tolerance difference value from the target piston position, this is an indication that in the pipetting space 28 there is present a dosing fluid amount which deviates quantitatively from the ascertained initial quantity 31′, where the deviation of the dosing fluid amount exceeds a tolerable amount.

The control device 24 then outputs to an output device 56 an appropriate warning message that a previous dispensing process, preferably the immediately previous dispensing process, has not been carried out correctly.

The conditioning procedure described above can be performed between two gas-sound-induced dispensing processes respectively following one another directly, such that the respective subsequent dispensing process can be carried out under optimal conditions. Likewise, between two sound-induced dispensing processes respectively following one another directly, the quality of the respective preceding dispensing process can be checked with regard to its dispensing accuracy. If an inadequate dispensing accuracy is established, the operation of the pipetting device can be stopped before performing further dispensing processes.

The pipetting tip 26 can be a conventional pipetting tip with a nominal pipetting space volume in a range from 10 μl to 20 ml. The single dosing volume 54 lies in the two-digit nanoliter range, for instance in a range from 40 to 60 nl. These are merely exemplifying data, which are meant to make the capability of the pipetting device 10 with at the same time simple structural layout comprehensible.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A pipetting device for dispensing a small dosing fluid amount of less than 1 μl, comprising:
a fluid volume,
a pipetting piston displaceable along a piston path, where a displacement of the pipetting piston effects a first pressure change in the fluid volume,
a movement drive which is connected with the pipetting piston in a force-transmitting manner in order to drive the pipetting piston to a movement along the piston path,
an acoustic source which is designed to produce at least one acoustic pulse as a second pressure change in the fluid volume, where the second pressure change effects the dispensing release of a dosing fluid droplet as the small dosing fluid amount,
a control device which is designed to control the movement drive and the acoustic source,
wherein the pipetting device comprises a pipetting duct extending along a duct axis, in which both the pipetting piston is accommodated movably along the duct axis as the piston path and the fluid volume is accommodated, where the fluid volume comprises a working gas which wets a pipetting surface of the pipetting piston, where furthermore the acoustic source is configured and arranged in the working gas for producing the at least one acoustic pulse.

17. The pipetting device according to claim 16, wherein the acoustic source exhibits an acoustic output surface wetted by the working gas, which produces at least one acoustic pulse.

18. The pipetting device according to claim 16, wherein from the pipetting duct there projects an ancillary space with an ancillary space volume, where the ancillary space volume with the duct volume of the pipetting duct forms a contiguous working gas-containing volume and where the acoustic source produces the at least one acoustic pulse in the ancillary space volume.

19. The pipetting device according to claim 18, wherein the acoustic source exhibits an acoustic output surface wetted by the working gas, which produces at least one acoustic pulse and the acoustic output surface forms a boundary wall of the ancillary space.

20. The pipetting device according to claim 19, wherein the ancillary space exhibits an ancillary duct extending along an ancillary duct axis and opening into the pipetting duct, where the ancillary duct axis encloses an angle with the duct axis.

21. The pipetting device according to claim 18, wherein the ancillary space exhibits an ancillary duct extending along an ancillary duct axis and opening into the pipetting duct, where the ancillary duct axis encloses an angle with the duct axis.

22. The pipetting device according to claim 16, wherein the pipetting device exhibits a pressure sensor which detects a working gas pressure of the working gas in the fluid volume and outputs a pressure signal which represents the detected working gas pressure.

23. The pipetting device according to claim 22, wherein the ancillary space exhibits an ancillary duct extending along an ancillary duct axis and opening into the pipetting duct, where the ancillary duct axis encloses an angle with the duct axis and the ancillary duct opens into an outlet region in the pipetting duct, where the pressure sensor is arranged in such a way that it detects the working gas pressure in the outlet region.

24. The pipetting device according to claim 22, wherein the control device is designed on the basis of at least one pressure signal of the pressure sensor and on the basis of data stored in a data memory which can be interrogated by the control device, between a first, earlier dispensing of a dosing fluid amount of less than 1 μl and a second, later dispensing of a dosing fluid amount of less than 1 μl following the former immediately, each effected by a second pressure change, to condition a dosing fluid reservoir accommodated in the pipetting duct, where for this purpose the control device is designed
to ascertain an initial quantity value which represents an initial quantity of dosing fluid which is accommodated in the pipetting duct after the dispensing of the first and before the dispensing of the second dosing fluid amount,
depending on the ascertained initial quantity value and depending on initial quantity value-working gas pressure assigning information stored in the data memory, which to each of different initial quantity values assigns a target working gas pressure, to ascertain a target working gas pressure for the working gas present in the pipetting duct, and
to actuate the movement drive to move the pipetting piston in the pipetting duct in such a way that the actual working gas pressure detected by the pressure sensor corresponds to the ascertained target working gas pressure.

25. The pipetting device according to claim 24, wherein the control device is designed to ascertain the initial quantity value on the basis of a preceding known initial quantity value and of a dosing fluid amount dispensed since the applicability of this preceding known initial quantity value.

26. The pipetting device according to claim 25, wherein the control device is designed to ascertain a dosing fluid amount dispensed in a time interval on the basis of a number of acoustic pulses produced in this time interval by the acoustic source for the dispensing of dosing fluid amounts, on the basis of their respective acoustic pulse form, and on the basis of acoustic pulse-dispensing amount assigning information stored in the data memory, which for at least one dosing fluid assigns to different acoustic pulse forms a dosing fluid amount dispensed by the respective acoustic pulse form.

27. The pipetting device according to claim 24, wherein the ancillary space exhibits an ancillary duct extending along an ancillary duct axis and opening into the pipetting duct, where the ancillary duct axis encloses an angle with the duct axis and the ancillary duct opens into an outlet region in the pipetting duct, where the pressure sensor is arranged in such a way that it detects the working gas pressure in the outlet region.

28. The pipetting device according to claim 16, wherein the pipetting device exhibits a piston position sensor for detecting the position of the pipetting piston along the duct axis, where the piston position sensor outputs a piston position signal which represents the detected position of the pipetting piston and/or that the pipetting device exhibits an acoustic position sensor for detecting the position of an acoustic output surface of the acoustic source, where the acoustic position sensor outputs an acoustic position signal which represents the detected position of the acoustic output surface.

29. The pipetting device according to claim 28, wherein the control device is designed to ascertain a target piston position of the pipetting piston from either initial quantity value-piston position assigning information stored in the data memory, which for at least one dosing fluid assigns different initial quantity values to each target piston position,
or from working gas pressure piston position assigning information stored in the data memory, which for at least one dosing fluid assigns different target working gas pressures to each target piston position,
where the control device is further designed, after actuation of the movement drive for changing the actual working gas pressure to the target working gas pressure, on the basis of the piston position signal to ascertain an actual piston position of the pipetting piston and to compare it with the target piston position and depending on the result of the comparison to output to an output device quality information about an accuracy of a previous dispensing process.

30. The pipetting device according to claim 29, wherein the control device is designed to output quality information at least when the difference between the actual piston position and the target piston position quantitatively exceeds a predetermined tolerance difference value.

31. The pipetting device according to claim 16, wherein the pipetting duct exhibits a pipetting aperture at which or through which a dosing fluid amount of less than 1 μl is dispensed, where the pipetting aperture is configured at a pipetting tip connected detachably with a pipetting duct section which accommodates the pipetting piston.

32. The pipetting device according to claim 16, wherein in a dispensing-ready operational state, the fluid volume comprises in addition to the working gas a dosing fluid reservoir, where the working gas wets an interface of the dosing fluid which faces towards the pipetting piston.
